(19) United States
(12) Patent Application Publication
(10) Pub. No.: US 2004/0149073 A1
(43) Pub. Date: Aug. 5, 2004

(54) Stop device comprising a slide-type regulating element

(76) Inventor: Roland Ruegenberg, Bad Sobernheim (DE)

Correspondence Address: JACOBSON HOLMAN PLLC, 400 SEVENTH STREET N.W., SUITE 600, WASHINGTON, DC, 20004, US

(21) Appl. No.: 10/476,880

(22) PCT Filed: May 15, 2002
(86) PCT No.: PCT/DE02/01739

(30) Foreign Application Priority Data
May 15, 2001 (DE) 101 23 537.2

(51) Int. Cl. G05G 5/06

(52) U.S. Cl. 74/527

(57) ABSTRACT

The invention relates to a stop device (1). The control element (2) of said stop device, which is provided with notches (5), can be displaced past a fixed stop member (6) comprising a stop element (8) which supports itself in an elastic manner on a cam plate (3) of the regulating element (2). Said stop element (8) is held on an elastically positioned base part (7) of the stop member (6) in the direction of regulation, in such a way that it can be deviated. When a summit (4) of the cam plate (3) is passed, the restoring force of the stop element (8) causes a secure engagement in the following notch (4).

The invention relates to a snap unit with a snap link and a slide-like actuator that can be adjusted relative to the same, whereby the snap link has a base component that can be moved by spring force lateral to the direction of position, and a snap element that is seated on the same, which is supported at a snap curve of the actuator, which is equipped with snap notches and descending slopes, whereby the snap element is movably seated at the base component under the force action of the descending slope in the direction of position.

Such a snap unit can be used in all switches with at least two steady switch positions, such as in a signal, light, or wiper blade switch of an automobile.

This type of snap unit is known, for instance, from U.S. Pat. No. 5,801,346 A (FIGS. 4, 7). A rotor is equipped with a radial bore, in which a coil spring is inserted with a snap ball, which abuts to the revolving spring curve of a stator. The spring curve is equipped successively with hump-like peaks, or notch-like recesses, respectively, into which the snap ball that is guided in the bore is pushed into a snapping position, whereby descending slopes extend between the peaks and recesses. This presents the risk that the slide remains in a non-functional position, in which the snap ball is currently present in the area of a snap peak under the gliding drive of the increased spring force. In order to reduce this risk, the peaks must be embodied as sharp-edged as possible. However, they can experience heavy wear, especially under the concentrated load of the snap ball so that the safety of operation is further reduced.

According to EP 0549870 A, the snap link gliding between two lateral movable spiral springs is movably seated in the direction of position along the snap curve, and is returned to its center position by the reset force of the spiral spring after exceeding the snap point. In the center position, the reset force of the spiral springs is low. Under the hysteresis of the wear-causing friction, the center position of the snap element is not defined exactly.

The invention is based on the task of improving the snap effect.

This task is solved by the characteristics stated in claim 1.

With the linear or rotatory sliding of the actuator relative to the snap link, the rolling element rolls from its centering position free of friction and smoothly into a moving position. The spring-loaded base component is laterally fixed. Haptics can be additionally influenced by means of the design of the descending curves on the base component. In the upper dead center of the respective snap point, the reset force is larger than the friction force, which causes the snap element, which has moved opposite of the direction of position, to roll back into its base position, thus engaging into the next snap notch of the snap curve. This makes it possible to round off the snap peaks of the snap curve even stronger, and thereby improve operation haptics and reduce wear. The rolling element is retained in the center position in the funnel-shaped centering groove in a positive fit, which results in an exactly defined snap position of the actuator.

An additional advantage consists of the fact that the snap element is moved not only laterally in the direction of position, but also vertically in a designable curve relative to the same. This results in an additional spring path with additional reset reserves in the snap direction, which further improves snapping safety.

Advantageous embodiments of the invention are found in the characteristics of claims 2 to 7.

In the same manner, the snap unit can be activated in the opposite directions by means of the further embodiment according to claims 2 and 3.

By means of the further embodiment according to claim 4, the maximum operating force can be reduced for less severe haptics, whereby the rolling back of the rolling element results in a clearly noticeable snapping effect.

By means of the stop flanks according to claim 5, the lateral moving motion of the snap element can be limited, and the initial reset force can be increased.

The further embodiment according to claim 6 results in an increased reset force across a longer rolling path.

The snap ball according to claim 7 can be embodied as a high-quality, inexpensive bearing ball. It is retained and safely guided in a simple manner in a funnel-shaped recess of the base component.

An embodiment example of the invention is schematically illustrated in the drawing, and will be explained in detail as follows. The figures show:

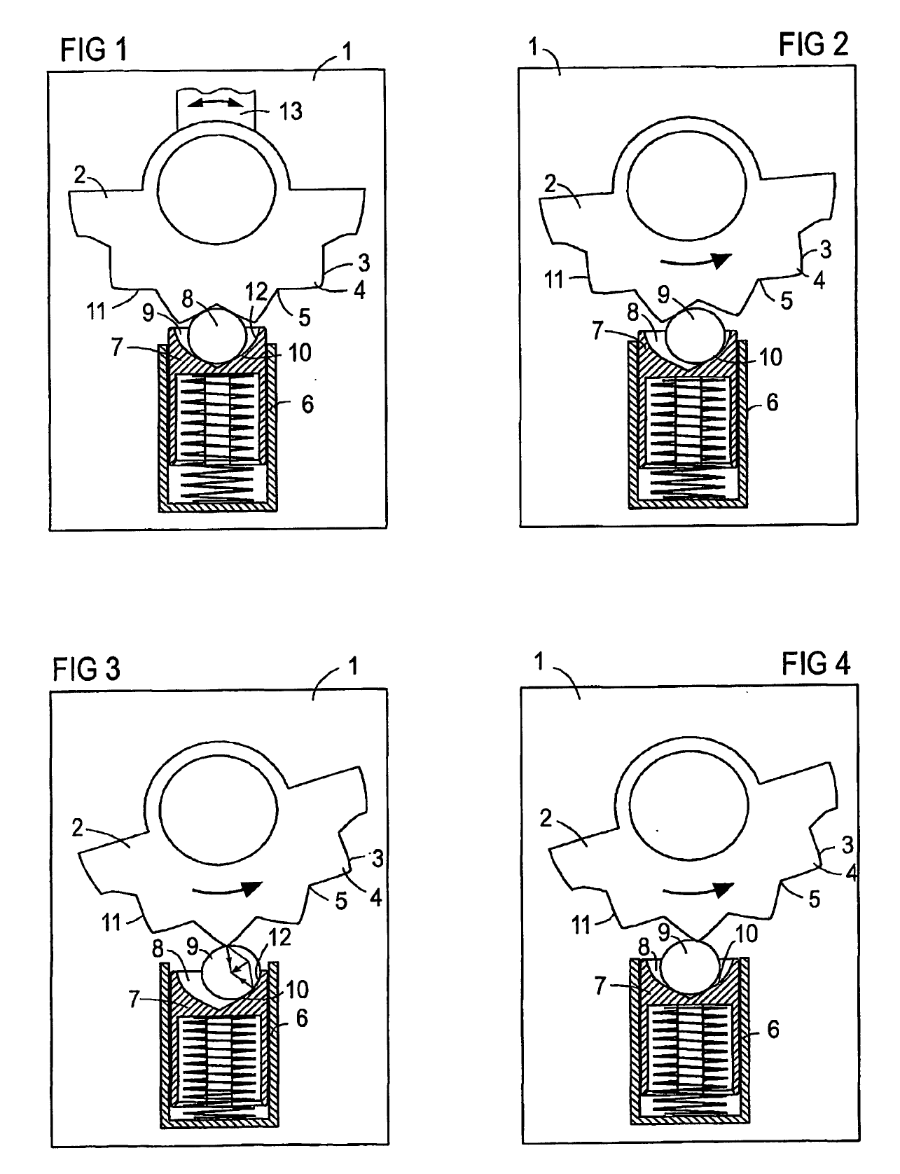

FIG. 1 a snap unit with a pivot-seated actuator in a base position

FIG. 2 the snap unit according to FIG. 1 in an intermediate position,

FIG. 3 the snap unit according to FIG. 1 in a successive position before the re-snapping of a snap element,

FIG. 4 the snap unit according to FIG. 3 after the re-napping of the snap element.

According to FIG. 1, a snap unit 1 has a pivot-seated actuator 2 with a peripheral snap curve 3 with snap peaks 4 and snap notches 5 that are distributed in a pitch circle. A stationary snap link 6 arranged radial to the actuator consists of a radial spring-loaded base component 7 and a rolling element in the shape of a bearing ball that serves as a snap element 8, which is roll-seated in a funnel-shaped recess of the base component 7 that is embodied as a centering notch 9. The centering notch 9 has at least one ascending slope 10 inclining toward the snap curve 3 for the snap element 8, which can be rolled when the actuator is slid into the area of the ascending slope 10. The ascending slopes 10 of the base component 7 are limited by lateral stop flanks 12. The gradient of the ascending slopes 10 increases toward the stop flank.

The snap notches 5 of the actuator 2 are each formed by opposite slanting descending slopes 11 of the snap curve 3, whereby the same is embodied directly of the changing gradient of the multiple successively occurring descending slopes 11. The gradient of the descending slope decreases toward the snap peak 4. The actuator 2 can be activated in both pivot directions by means of a control lever 13.

According to FIG. 2, the actuator is further pivoted by approximately one fourth of an adjustment, whereby the snap element 8 is rolled in a free intermediate position along the descending slope 11 and the ascending slope 10. The base component has thereby been moved by a stroke perpendicular to the direction of adjustment resulting from the two gradients and the lateral movement.

According to FIG. 3, the actuator 2 has been further pivoted into a threshold position, in which the snap element 8 is currently located on the point of the snap peak 4, and abuts to the stop flank 12 of the base component 7. The reset force resulting from the clamping force is already slightly larger than the friction force so that the snap element 8 can snap back into its median centering position illustrated in FIG. 4 along the ascending slope 10, as is observable in the force parallelogram indicated. In this way, the snap element 8 reaches the descending curve range of the next descending slope 11 via the snap point, without the actuator 2 having to actively pivot any further. The snap element 8 now pushes on this descending slope 11 in such a way that the actuator is independently and safely moved further into the next snap position according to the curved arrow.

Reference Symbols

1 Snap unit

2 Actuator

3 Snap curve

4 Snap point

5 Snap notch

6 Snap link

7 Base component

8 Snap element

9 Centering notch

10 Ascending slope

11 Descending slope

12 Stop flank

13 Control lever

1. Snap unit (1) with a snap link (6) and a slide-like actuator (2) that can be adjusted relative to the same,
whereby the snap link (6) has a base component (7) that can be moved by spring force lateral to the direction of position, and a snap element that is seated on the same, which is supported at a snap curve (3) of the actuator (2), which is equipped with snap notches (5) and descending slopes (11) and,
whereby the snap element (8) is movably seated at the base component (7) under the force action of the descending slope (11) in the direction of position, characterized in that
the snap element (8) is embodied as a rolling element that is seated in a rolling manner in the direction of position, and received in a recess of the base component (7);
that the recess is embodied as a centering notch of the snap link (6), which is open toward the snap curve (3),
that the centering notch (9) has at least one ascending slope (10) inclining toward the snap curve (3) for the snap element (8), and
that the rolling element can be rolled into the area of the ascending slope (10) during the sliding of the actuator (2).

2. Snap unit according to claim 1, characterized in that the centering notch (9) is embodied between two of the oppositely inclined ascending slopes (10), and that the snap notches (5) of the actuator (2) are embodied between the opposite inclined descending slopes (11) of the snap curve (3).

3. Snap unit according to claims 1 or 2, characterized in that the snap curve (3) is embodied directly of the successively occurring descending slopes (11) of changing gradients with snap balls (4) embodied between the snap notches (5).

4. Snap unit according to claim 3, characterized in that the gradient of the descending slope (11) decreases toward the snap point (4).

5. Snap unit according to one of the claims 1 to 4, characterized in that the ascending slopes (10) of the snap link (6) are limited by lateral stop flanks (12).

6. Snap unit according to claim 5, characterized in that the gradient of the ascending slope (10) increases toward the stop flank (12).

7. Snap unit according to one of the previous claims, characterized in that the snap element (8) is embodied in a ball shape, and the centering notch (9) is embodied in a funnel shape.
